(19) United States
(12) Patent Application Publication
(10) Pub. No.: US 2023/0180668 A1
(43) Pub. Date: Jun. 15, 2023

(54) CHUTE ASSEMBLY FOR AGRICULTURAL BALER

(71) Applicant: AGCO Corporation, Duluth, GA (US)

(72) Inventor: John D. Russell, Pemberville, OH (US)

(21) Appl. No.: 18/065,363

(22) Filed: Dec. 13, 2022

Related U.S. Application Data
(60) Provisional application No. 63/289,182, filed on Dec. 14, 2021.

(51) Int. Cl. A01F 15/08; A01F 15/04; A01F 15/14

(52) U.S. Cl. CPC A01F 15/0875; A01F 15/046; A01F 15/14; A01F 15/042

(57) ABSTRACT

A baler a chute assembly extending in a rearward direction from a baling chamber configured to simultaneously receive first and second bales as the bales are urged out of the baling chamber. The chute assembly includes a rail assembly and an opposing shelf assembly, the rail assembly and the shelf assembly cooperating to form a cavity therebetween. The rail assembly includes an upper rail and a lower rail with the lower rail offset from the upper rail in a horizontal direction toward the cavity, and the shelf assembly includes a horizontal first surface, an ejection plate, an angled second surface and a guide rail. As the first and second bales are urged from the bale chamber the first bale engages the rail assembly and the second bale engages the shelf assembly. The chute assembly rotates the first and second bales as the bales drop from the chute assembly in a single line of bales arranged in an end-to-end orientation.

### CROSS-REFERENCE TO RELATED APPLICATIONS

This application claims the benefit of U.S. Provisional Application No. 63/289,182, filed Dec. 14, 2021, which is hereby incorporated by reference in its entirety.

### BACKGROUND OF THE INVENTION

### Field of Invention

This disclosure relates agricultural balers, and more particularly to a chute assembly of the baler that rotates the first and second bales as the bales drop from the chute assembly in a single line of bales arranged in a spaced apart end-to-end orientation.

### Description of Related Art

Agricultural harvesting machines, such as balers, are commonly used to consolidate and package crop material so as to facilitate the storage and handling of the crop material for later use. In the case of hay, a mower-conditioner is typically used to cut and condition the crop material for windrow drying in the sun. In the case of straw, an agricultural combine discharges non-grain crop material from the rear of the combine defining the straw (such as wheat or oat straw) which is to be picked up later by the baler. The cut crop material is typically raked and dried, and a baler, such as a square baler or round baler, straddles the windrows and travels along the windrows to pick up the crop material and form it into bales.

Balers typically include a pickup unit, located at the front of the baler, and configured to gather the cut and windrowed crop material from the ground. Balers occasionally also include a packer unit to move the crop material from the pickup unit to a duct or pre-compression chamber. The packer unit forms a wad of crop within the pre-compression chamber. The wad of crop is then transferred to a bale chamber. In certain instances, a rotor cutter can be used in lieu of the packer unit, with the rotor cutter chopping the crop material into smaller pieces.

Balers can also include a stuffer unit that transfers the wad of crop material in charges from the pre-compression chamber to the bale chamber, in sequence with the reciprocating action of a reciprocating plunger within the bale chamber. In the bale chamber, the reciprocating plunger compresses the wad of crop material into flakes to form a bale and, at the same time, gradually advances the bale toward the outlet of the bale chamber.

When enough flakes have been added and the bale reaches a full (or other predetermined) size, a plurality of knotters are actuated which wrap and tie twine, cord, or the like around the bale while it is still in the bale chamber. The twine is cut, and the formed bale is ejected from the rear of the baler, as new bales are formed.

The process of picking up the crop material and forming it into bales can be time consuming. It would be advantageous if the process of picking up the crop material, forming the crop material into bales and subsequently retrieving the bales could be improved.

### BRIEF SUMMARY

In one aspect, the invention is directed to an agricultural baler having a pickup assembly configured to take cut plant material from the ground and move the plant material to a baling chamber and compress the plant material in the baling chamber with a reciprocating plunger into a growing bale. The baler includes a stationary knife mounted in the baling chamber extending vertically between the floor and the roof such that plant material moved into the baling chamber is split by movement of the plunger relative to the knife to simultaneously form a first bale on one side of the knife and a second bale on an opposite side of the knife. The baler includes a chute assembly extending in a rearward direction from the baling chamber configured to simultaneously receive the first and second bales as the bales are urged through out of the baling chamber. The chute assembly includes a rail assembly and an opposing shelf assembly, the rail assembly and the shelf assembly cooperating to form a cavity therebetween, where the rail assembly includes an upper rail and a lower rail with the lower rail is offset from the upper rail in a horizontal direction toward the cavity, and where the shelf assembly includes a horizontal first surface, an ejection plate, an angled second surface and a guide rail. As the first and second bales are urged from the bale chamber the first bale engages the rail assembly and the second bale engages the shelf assembly. The chute assembly rotates the first and second bales as the bales drop from the chute assembly in a single line of bales arranged in a spaced apart end-to-end orientation.

These and other features and advantages of this invention are described in, or are apparent from, the following detailed description of various exemplary embodiments of the systems and methods according to this invention.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a perspective view of an agricultural baler in accordance with the invention.

FIG. 2 is a right-side perspective view of the agricultural baler of FIG. 1.

FIG. 3 is a plan view schematic illustration of a processing unit and a chute assembly forming the agricultural baler of FIG. 1.

FIG. 4A and FIG. 4B are side views illustrated in cross-section of the agricultural baler of FIG. 1.

FIG. 5 is a left-side perspective view of a chute assembly of the agricultural baler of FIG. 1.

FIG. 6 is a rear perspective view of a chute assembly of the agricultural baler of FIG. 1.

FIG. 7 is a perspective view of the agricultural baler of FIG. 1 illustrating an operational step.

FIG. 8 is a perspective view of the agricultural baler of FIG. 1 illustrating another operational step.

FIG. 9 is a perspective view of the agricultural baler of FIG. 1 illustrating another operational step.

FIG. 10 is a perspective view of the agricultural baler of FIG. 1 illustrating another operational step.

FIG. 11 is a perspective view of the agricultural baler of FIG. 1 illustrating a single line of bales, arranged in a spaced apart end-to-end orientation.

FIG. 12 is a perspective view of the agricultural baler of FIG. 1 illustrating another operational step.

### DETAILED DESCRIPTION

The agricultural baler will now be described with occasional reference to specific embodiments. The agricultural baler may, however, be embodied in different forms and should not be construed as limited to the embodiments set forth herein. Rather, these embodiments are provided so that this disclosure will be thorough and complete, and will fully convey the scope of the agricultural baler to those skilled in the art.

Unless otherwise defined, all technical and scientific terms used herein have the same meaning as commonly understood by one of ordinary skill in the art to which the agricultural baler belongs. The terminology used in the description of the agricultural baler herein is for describing particular embodiments only and is not intended to be limiting of the agricultural baler. As used in the description of the agricultural baler and the appended claims, the singular forms “a,” “an,” and “the” are intended to include the plural forms as well, unless the context clearly indicates otherwise.

Unless otherwise indicated, all numbers expressing quantities of dimensions such as length, width, height, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the agricultural baler. Notwithstanding that the numerical ranges and parameters setting forth the broad scope of the agricultural baler are approximations, the numerical values set forth in the specific examples are reported as precisely as possible. Any numerical values, however, inherently contain certain errors necessarily resulting from error found in their respective measurements.

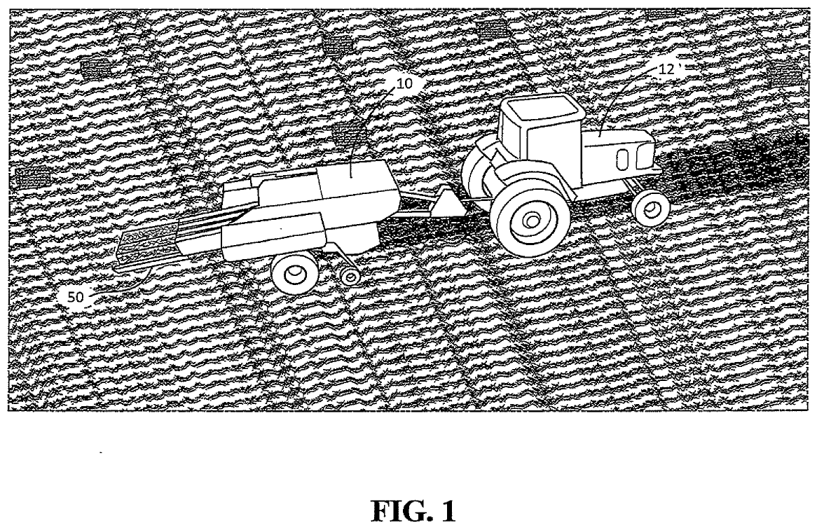

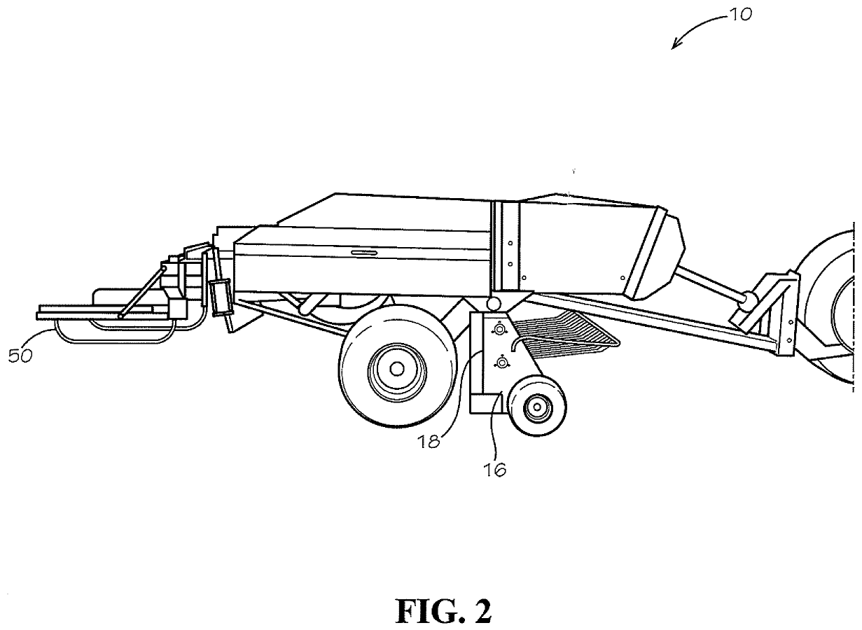

Referring to FIG. 1, an example agricultural baler 10 is shown into which embodiments of the present invention may be incorporated. The baler 10 may be hitched to a towing vehicle 12, and power for operating the various mechanisms (e.g., the reciprocating plunger, described below) of the baler 10 may be supplied by a power take-off of the towing vehicle 12. Although the example baler 10 is a towed square baler, it will be appreciated that embodiments of the present invention may be incorporated into other types of balers (e.g., self-propelled) with few or no changes. Broadly, the baler 10 may be configured to move over a field and collect previously cut plant material and to compress, shape, and secure the collected plant material into a plurality of bales. As shown in FIG. 2, the baler 10 may generally include a pickup assembly 16 and a stuffer chute assembly 18 as is known in the art. The pickup assembly 16 may be configured to collect the cut plant material from the field as the baler 10 moves over the field.

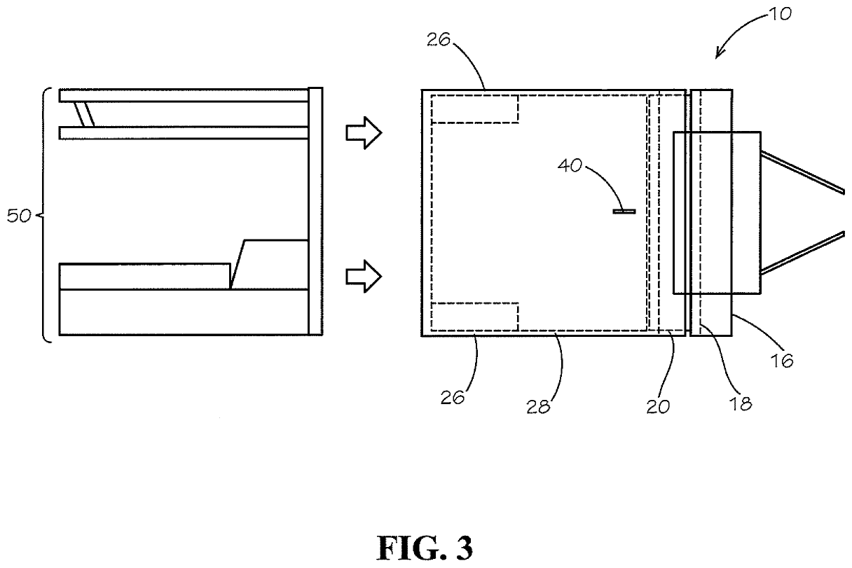

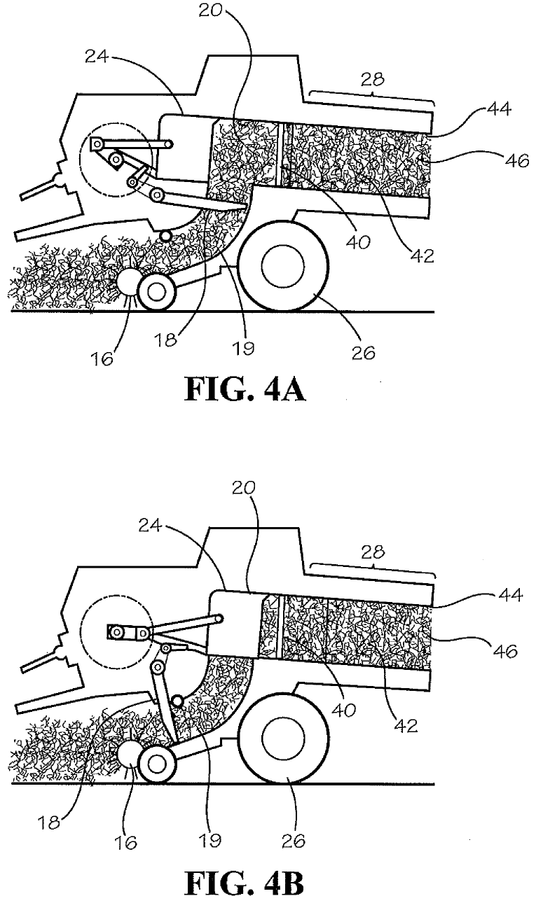

The stuffer chute assembly 118 may be configured to direct the collected plant material into position for incorporation into a bale. Turning also now to FIG. 3 and FIGS. 4A and 4B, the stuffer chute assembly 18 may include a charge-forming duct 19 extending from an inlet opening adjacent to the pickup assembly 16 to an outlet opening into a baling chamber 20. A reciprocating plunger 24 may be configured to compress the plant material from the charge-forming duct 19 into a growing bale. In one implementation, the plunger 24 may be configured to reciprocate within the baling chamber 20 in repeating compression and retraction strokes across the outlet opening of the charge-forming duct 19. As the plunger 24 retracts, the outlet opening is uncovered and an additional flake, charge, or other subunit of plant material enters the baling chamber 20, and as the plunger 24 contracts the outlet opening is covered, and the additional subunit of plant material is compressed into the growing bale. The plunger 24 is hydraulically moved rearward to compress the plant material received in the baling chamber 20 from the stuffer chute assembly 18 such that the plunger 24 pushes the crop material against and past a stationary splitting knife 40 which extends vertically in the baling chamber 20 between the floor in a plane parallel with the side walls of the baling chamber 20. The compressed crop material split by movement of the plunger 24 relative to the knife 40 is pushed into a bale-forming compartment 28 where discrete bodies 42 formed by the knife are pushed by the urging of successive flakes in a direction toward an exit 44 of the bale chamber 20. The plunger 24 comes close to contacting the knife 40 but, preferably, does not contact the knife 40.

Referring again to FIGS. 4A and 4B, as the discrete bodies 42 are urged through the bale forming compartment 28 of the baling chamber 20, one or more binding assemblies (not shown for purposes of clarity) engage the discrete bodies 42 with a binding material, such as the non-limiting example of twine, thereby forming bales 46.

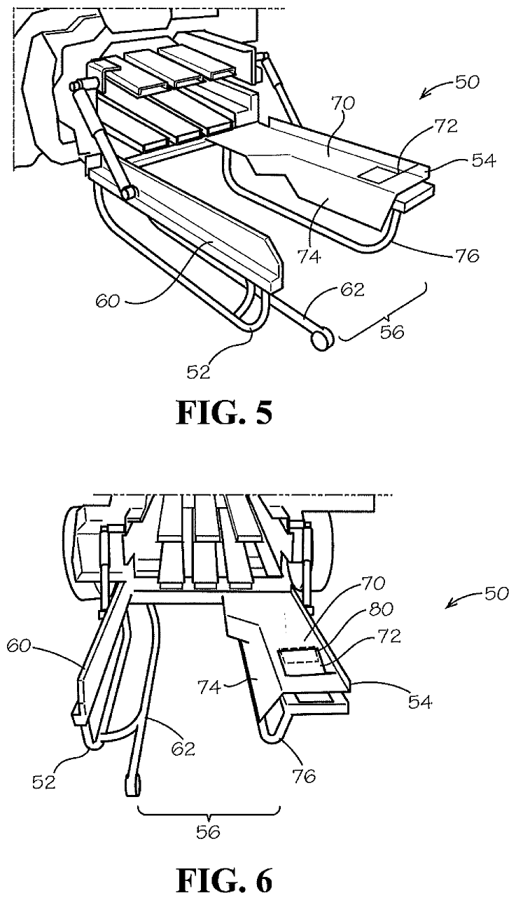

Referring now to FIGS. 5 and 6, a chute assembly 50 extends in a rearward direction from the baling chamber 20. The chute assembly 50 is configured for several functions. First, the chute assembly 50 is configured to receive the bales 46 as the bales 46 are urged through the exit 44 the baling chamber 20. Second, the chute assembly 50 is configured to stage the bales 46 in a manner such as to sequentially drop the bales 46 on the ground in a desired manner. Third, the chute assembly 50 is configured to rotate the bales 46 as the bales drop from the chute assembly 50. Fourth, the chute assembly 50 is configured to drop the bales 46 in a single line of bales, arranged in a spaced apart end-to-end orientation.

The chute assembly 50 includes a rail assembly 52 and an opposing shelf assembly 54. The rail assembly 52 and the shelf assembly 54 cooperate to form a cavity 56 therebetween. The rail assembly 52 includes an upper rail 60 and a lower rail 62. The lower rail 62 is offset from the upper rail 60 in a horizontal direction toward the cavity 56. The shelf assembly 54 includes a substantially horizontal first surface 70, an ejection plate 72, an angled second surface 74 and a guide rail 76.

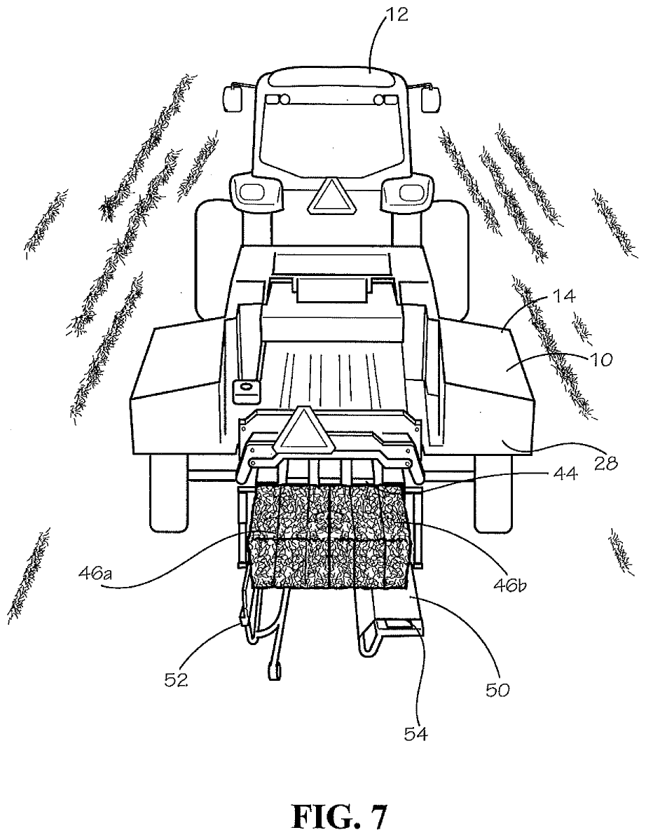

Referring now to FIGS. 7-12, operation of the baler 10 and the novel chute assembly 50 will now be described. Referring first to FIG. 7, the baler 10 is towed behind the motive source 12 in a manner as described above. The motive source 12 pulls the baler 10 over cut crop material such that the baler 10 collects the cut crop material from the ground and forms bales 46a, 46b as described above and shown in FIGS. 4A and 4B. The bales 46a, 46b are urged from the exit 44 of the bale 20 by the plunger 24 in a manner such that the bales 46a, 46b are arranged in a side-by-side orientation. Simultaneously, the bale 46a engages the rail assembly 52 and the bale 46b engages the shelf assembly 54. The upper rail 60 (FIG. 6) of the rail assembly 52 and the first surface 70 of the shelf assembly 54 maintain the bales 46a, 46b in a side-by-side orientation as the bales 46a, 46b advance.

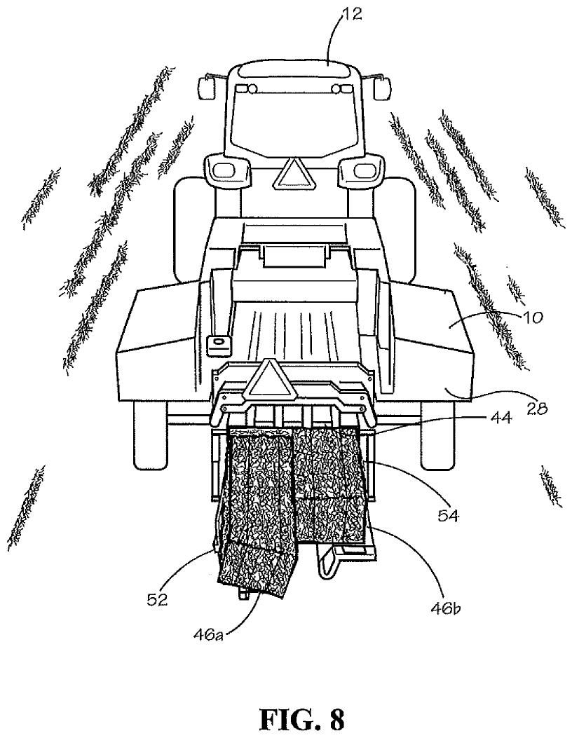

Referring now to FIG. 8 in a next step, bales 46a, 46b are simultaneously urged from the exit 44 of the baling chamber 20 a sufficient distance such as not to be supported by the bale chamber 28. At this point, the bale 46a falls in a direction toward the ground. As the bale 46a falls, the bale 46a engages the lower rail 62 (FIG. 6), thereby causing the bale 46a to be rotated 90 degrees and directing the bale 46a into the cavity 56. At the same time, the bale 46b is still supported by the shelf assembly 54, thereby preventing the bale 46b from moving in a vertical direction.

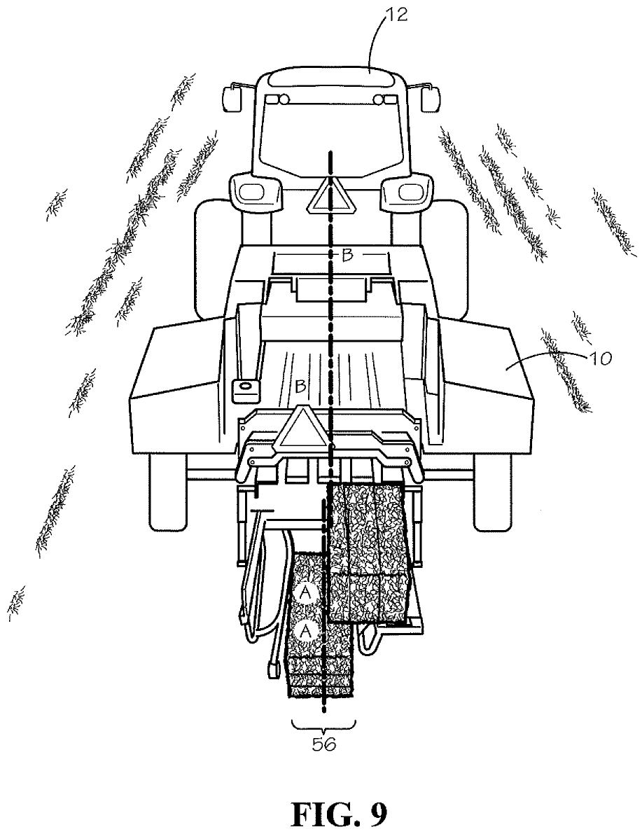

Referring now to FIG. 9, in a next step the bale 46a falls through the cavity 56 and lands on the ground in an upright orientation. The term “upright orientation”, as used herein, is defined to mean the binding material used to bind the bale 46 is wrapped around the four vertical sides of the bale and the narrow sides of the rectangular shaped bale 46 are on the top and bottom of the bale 46 such that the twine binding the bale 46a the vertical sides does not touch the ground. Upon landing on the ground, the bale 46a is prevented from further rotation by contact with the guide rail 76. In this orientation, a longitudinal axis A-A of the bale 46a is substantially parallel to a longitudinal axis B-B of the baler 10. At the same time, the bale 46b remains supported by the shelf assembly 54, thereby preventing the bale 46b from moving in a vertical direction.

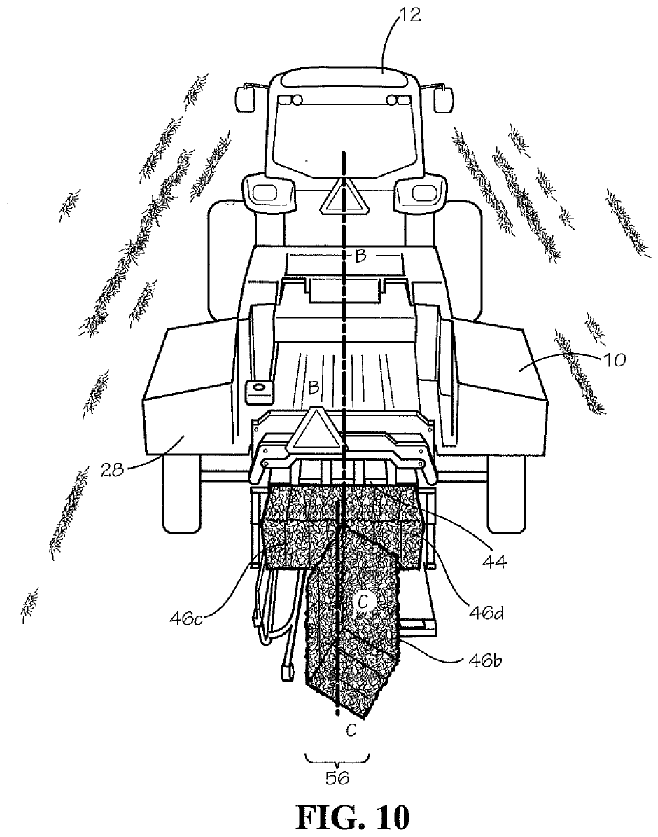

In a next step, as shown in FIG. 10, successively formed bales 46c, 46d advance from the exit 44 of the bale chamber 28. Bale 46d urges the bale 46b further onto the shelf assembly 54 and along the horizontal first surface 70 and into engagement with the ejection plate 72 (FIG. 9). Further urging by the successive bale 46d forces the bale 46b to lose fall from horizontal first surface 70 and into contact with the angled second surface 74 (FIG. 6). The angled second surface 74 directs the bale 46b into the cavity 56. The bale 46b falls through the cavity 56 and lands on the ground in an upright orientation. The bale 46b is prevented from further rotation by contact with the lower rail 62 and the guide rail 76. Upon landing on the ground, the bale 46b has an orientation such that a longitudinal axis C-C of the bale 46b is substantially parallel to a longitudinal axis B-B of the baler 10 and further is substantially parallel with the longitudinal axis A-A of the bale 46a.

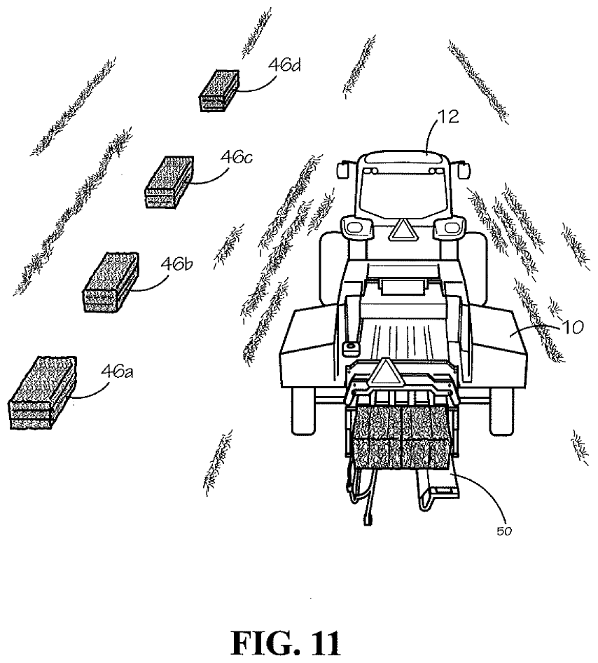

Referring now to FIG. 11, dropped bales 46a-46d are illustrated. The dropped bales 46a-46d form a single line of bales, arranged in a spaced apart end-to-end orientation. Advantageously, the single line of bales allows a stacker machine (not shown) to drive in a single line to obtain the dropped bales 46a-46d.

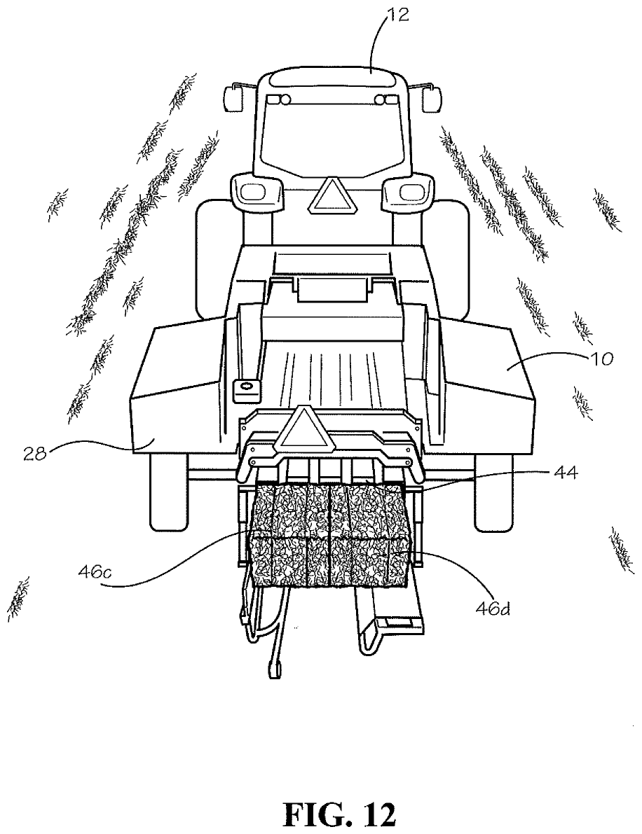

Referring now to FIG. 12, successive bales 46c, 46d are urged through the exit 44 of the bale chamber 28, thereby starting another series of spaced apart bales arranged in an end-to-end orientation.

Referring again to FIGS. 5 and 6, optionally, the chute assembly 50 can be equipped with a weigh system, shown schematically at 80. The weigh system 80 is configured to weigh a bale disposed on the shelf assembly 54. The weigh system can be in communication with baler controls (not shown) in a manner such that the density and weight of the bales can be adjusted to a desired level. The weigh system 80 can have any desired structure and configuration for weighing a bale disposed on the shelf assembly 54. However, it should be appreciated that the weight system 80 is optional and not required for operation of the novel chute assembly 50.

The baler 10 provide many benefits, although all benefits may not be available in all instances. The baler 10 effectively forms two rather than a single bale as formed by conventional balers, thereby doubling the capacity of the motive source 12 and baler 10.

In accordance with the provisions of the patent statutes, the principle and mode of operation of the novel agricultural baler have been explained and illustrated in a certain embodiment. However, it must be understood that the novel agricultural baler may be practiced otherwise than as specifically explained and illustrated without departing from its spirit or scope.

What is claimed is:

1. An agricultural baler having a pickup assembly configured to take cut plant material from the ground and move the plant material to a baling chamber and compress the plant material in the baling chamber with a reciprocating plunger into a growing bale, the baler comprising:
a stationary knife mounted in the baling chamber extending vertically between the floor and the roof such that plant material moved into the baling chamber is split by movement of the plunger relative to the knife to simultaneously form a first bale on one side of the knife and a second bale on an opposite side of the knife; and
a chute assembly extending in a rearward direction from the baling chamber configured to simultaneously receive the first and second bales as the bales are urged through out of the baling chamber, the chute assembly comprising a rail assembly and an opposing shelf assembly, the rail assembly, and the shelf assembly cooperating to form a cavity therebetween;
wherein the rail assembly includes an upper rail and a lower rail with the lower rail is offset from the upper rail in a horizontal direction toward the cavity;
wherein the shelf assembly includes a horizontal first surface, an ejection plate, an angled second surface and a guide rail, wherein as the first and second bales are urged from the bale chamber the first bale engages the rail assembly and the second bale engages the shelf assembly;
such that the chute assembly rotates the first and second bales as the bales drop from the chute assembly in a single line of bales arranged in a spaced apart end-to-end orientation.

2. The agricultural baler of claim 1 wherein the upper rail of the rail assembly and the first surface of the shelf assembly maintain the first and second bales in a side-by-side orientation as the bales advance out of the baling chamber.

3. The agricultural baler of claim 2 as the first and second bales advance a sufficient distance such as not to be supported by the bale chamber, the first bale falls in a direction toward the ground and engages the lower rail 62, thereby causing the first bale to be rotated 90 degrees and directing the first bale into the cavity, while the second bale is still supported by the shelf assembly, thereby preventing the second bale from moving in a vertical direction.

4. The agricultural baler of claim 3 the first bale falls through the cavity and lands on the ground in an upright orientation.

5. The agricultural baler of claim 4 wherein upon landing on the ground, the first bale is prevented from further rotation by contact with the guide rail.

6. The agricultural baler of claim 4 wherein the baler wraps the first and second bales with a binding material, when the first bale lands on the ground, the binding material is wrapped around the four vertical sides of the bale such that the binding material does not touch the ground.

7. The agricultural baler of claim 3 wherein after the first bales falls to the ground, the second bale falls from horizontal first surface and into contact with the angled second surface, the angled second surface directing the second bale into the cavity such that the second bale falls through the cavity and lands on the ground in an upright orientation.

8. The agricultural of claim 7 the second bale is prevented from further rotation by contact with the lower rail and the guide rail.

9. The agricultural baler of claim 1 wherein the baler binds the first and second bales with a binding material and the chute assembly rotates the first and second bales 90 degrees as the first and second bales are dropped from the chute assembly to the field such that the first and second bales come to rest in the field such that the binding material used to bind the first and second bales is wrapped around the four vertical sides of the first and second bales such that the binding material does not touch the ground.
